(19) United States
(12) Patent Application Publication
(10) Pub. No.: US 2015/0309909 A1
(43) Pub. Date: Oct. 29, 2015

(54) ELECTRONIC DEVICE AND FAULT ANALYSING METHOD

(71) Applicant: HON HAI PRECISION INDUSTRY CO., LTD., New Taipei (TW)

(72) Inventor: YAN-RUNG HUANG, New Taipei (TW)

(21) Appl. No.: 14/485,277

(22) Filed: Sep. 12, 2014

(30) Foreign Application Priority Data
Apr. 23, 2014 (TW) 103114606

(51) Int. Cl. G06F 11/32

(52) U.S. Cl. CPC G06F 11/324

(57) ABSTRACT

An electronic device includes a signal generator, a selecting unit, an acquisition unit, a storing unit, and a control unit. The control unit outputs a control signal to the selecting unit according to a signal selected by the user and reading a table of the storing unit. The selecting unit receives the control signal, to select a corresponding input connect to a corresponding output of the signal generator, to output a corresponding signal. The acquisition unit measures the corresponding signal to produce measurement data, compares the measurement data and a standard data to produce an analysis result, and send the analysis result to the control unit. The control unit sends the analysis result to a screen or a remote device to display.

### FIELD

The disclosure relates to electronic devices, and particularly to a fault analyzing method of electronic devices.

### BACKGROUND

Usually, a user can identify fault reasons of an electronic device according to fault signals.

### BRIEF DESCRIPTION OF THE DRAWINGS

Implementations of the present technology will now be described, by way of example only, with reference to the attached figures.

FIG. 1 illustrates a block diagram of an embodiment of an electronic device.

FIG. 2 illustrates a block diagram of another embodiment of an electronic device.

FIG. 3 is a flowchart of one embodiment of a fault analyzing method of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

The following disclosure is described in relation to an electronic device.

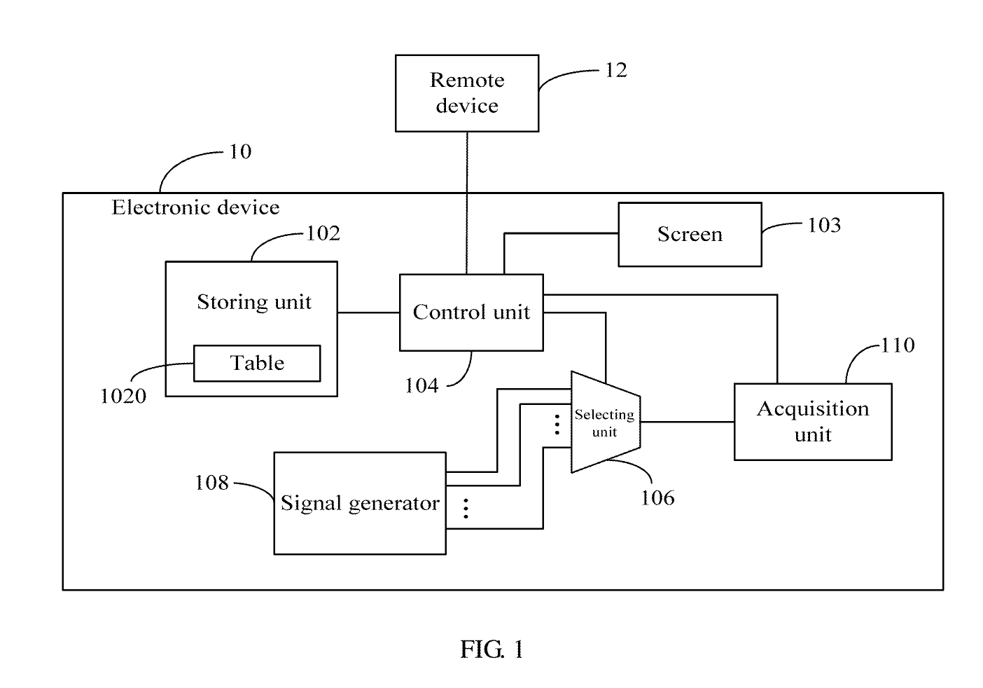

FIG. 1 illustrates an embodiment of an electronic device 10. In one embodiment, the electronic device 10 comprises a storing unit 102, a control unit 104, a selecting unit 106, a signal generator 108, an acquisition unit 110, and a screen 103.

The signal generator 108 comprises a plurality of outputs to output a plurality of different signals. In one embodiment, the different signals comprise a first signal, a second signal, a third signal, and so on. In one embodiment, the outputs of the signal generator 108 comprise a first output, a second output, a third output, and so on. Each output can output one corresponding signal. In one embodiment, the different signals comprise a field programmable gate array/complex programmable logic device (FPGA/CPLD) signal, a power signal, and a bus signal.

The selecting unit 106 comprises a plurality of inputs, an output, and a control port. The inputs of the selecting unit 106 are electronically connected to the corresponding outputs of the signal generator 108 to receive the different signals output by the signal generator 108. In one embodiment, the inputs of the selecting unit 106 comprise a first input, a second input, a third input, and so on. In one embodiment, the first input of the selecting unit 106 is electronically connected to the first output of the signal generator 108, the second input of the selecting unit 106 is electronically connected to the second output of the signal generator 108, the third input of the selecting unit 106 is electronically connected to the third output of the signal generator 108, and so on.

The storing unit 102 stores a table 1020, which stores a relationship between the inputs of the selecting unit 106 and the different signals of the signal generator 108. In one embodiment, the first input of the selecting unit 106 receives the first signal, the second input of the selecting unit 106 receives the second signal, the third input of the selecting unit 106 receives the third signal, and so on.

The control unit 104 is electronically connected to the storing unit 102, the control port of the selecting unit 106, and the screen 103. In one embodiment, a user can select a target signal to measure via the screen 103. In other embodiments, the control unit 104 is connected to a remote device 12, and the user can use the remote device 12 to select the target signal to measure. The control unit 104 can output a control signal to the selecting unit 106 according to the target signal selected by the user and the table 1020 of the storing unit 102. The selecting unit 106 selects a corresponding input of the selecting unit 106 to electronically connect to a corresponding output of the signal generator 108, according to the control signal, to control the signal generator 108 to output the corresponding signal to the acquisition unit 110. For example, when the target signal selected by the user is the first signal, the control unit 104 outputs a first control signal to the selecting unit 106, to control the first input of the selecting unit 106 to electronically connect to the first output of the signal generator 108. The signal generator 108 outputs the first signal to the selecting unit 106, and the acquisition unit 110 receives the first signal through the output of the selecting unit 106. In one embodiment, the control signal is a level signal.

The acquisition unit 110 comprises an input and an output. The input of the acquisition unit 110 is electronically connected to the output of the selecting unit 106, and the output of the acquisition unit 110 is electronically connected to the control unit 104. The acquisition unit 110 receives the corresponding signal output by the signal generator 108 from the selecting unit 106, and measures the corresponding signal to produce measurement data. In one embodiment, the acquisition unit 110 stores standard data. The acquisition unit 110 compares the measurement data to the standard data to produce an analysis result, and sends the analysis result to the control unit 104. In one embodiment, the control unit 104 sends the analysis result to the screen 103, and the screen 103 displays the analysis result. In one embodiment, the electronic device 10 can determine faults of the different signals by individually comparing the measurement data of each signal to the standard data. In other embodiments, the acquisition unit 110 can be shared by a plurality of electronic devices 10 to measure signals and compare measurement data to standard data.

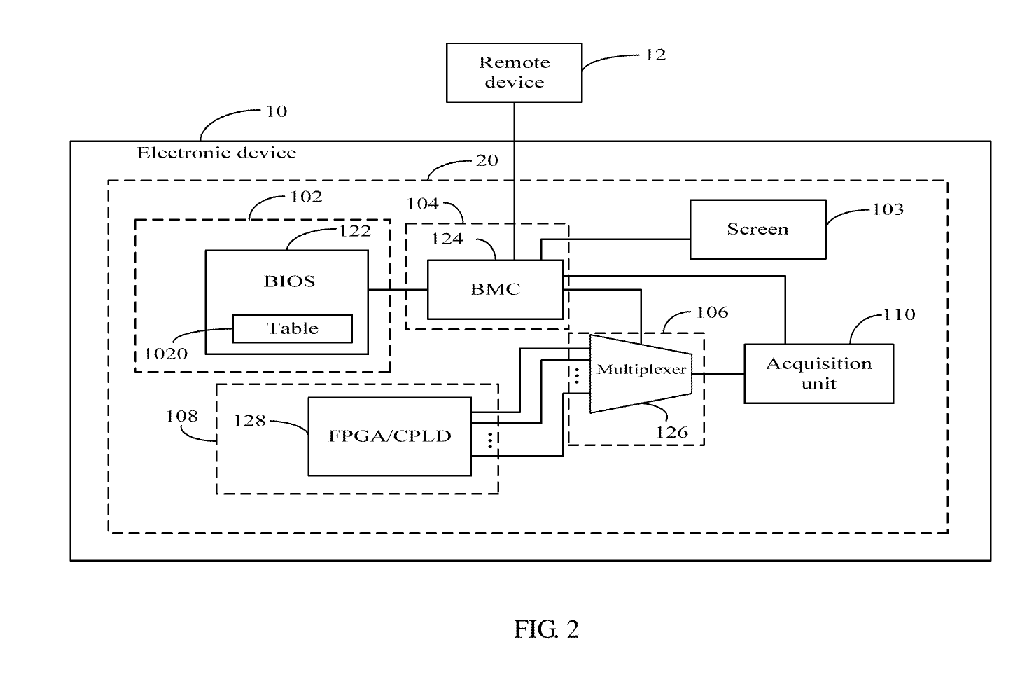

FIG. 2 illustrates another embodiment of an electronic device 10. In one embodiment, the electronic device 10 comprises a server 20. The server 20 comprises a storing unit 102, a control unit 104, a selecting unit 106, a signal generator 108, an acquisition unit 110, and a screen 103.

The signal generator 108 comprises an FPGA/CPLD 128. The FPGA/CPLD 128 comprises a plurality of outputs to output a plurality of different signals.

The selecting unit 106 comprises a multiplexer 126. The multiplexer 126 comprises a plurality of inputs, an output, and a control port. The inputs of the multiplexer 126 are electronically connected to the outputs of the FPGA/CPLD 128, respectively, to receive the different signals outputted by the FPGA/CPLD 128.

The storing unit 102 comprises a basic input/output system (BIOS) 122 of a baseboard of the server 20. The BIOS 122 stores a table 1020, which stores a relationship between the inputs of the multiplexer 126 and the different signals of the FPGA/CPLD 128.

The control unit 104 comprises a baseboard management controller (BMC) 124. The BMC 124 is electronically connected to the BIOS 122, the control port of the multiplexer 126, and the screen 103. A user can select a target signal to measure via the screen 103, and the BMC 124 outputs a control signal to the multiplexer 126 according to the target signal selected by the user and the table 1020.

The acquisition unit 110 comprises an input and an output. The input of the acquisition unit 110 is electronically connected to the output of the multiplexer 126, and the output of the acquisition unit 110 is electronically connected to the BMC 124. The acquisition unit 110 receives a corresponding signal outputted by the FPGA/CPLD 128, and measures the corresponding signal to produce measurement data. In one embodiment, the acquisition unit 110 stores standard data. The acquisition unit 110 compares the measurement data to the standard data to produce an analysis result, and sends the analysis result to the BMC 124. In one embodiment, the BMC 124 sends the analysis result to the screen 103, and the screen 103 displays the analysis result. In one embodiment, the electronic device 10 can determine faults of the different signals by individually comparing the measurement data of each signal to the standard data.

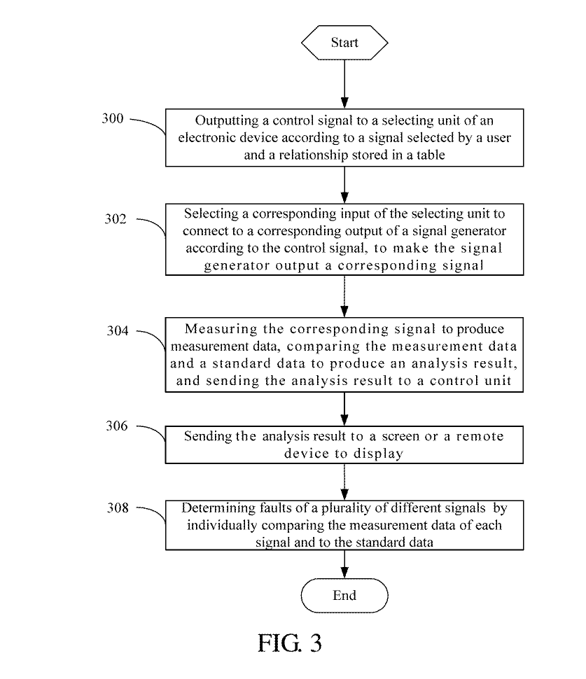

FIG. 3 is a flowchart of one embodiment of a fault analyzing method of the electronic device 10 as disclosed. The method can be based on the function modules of FIG. 1 or FIG. 2.

In block 300, a control unit outputs a control signal to a selecting unit according to a signal selected by a user and a relationship stored in a table of a storing unit.

In block 302, the control unit selects a corresponding input of the selecting unit to electronically connect to a corresponding output of a signal generator according to the control signal, to make the signal generator output a corresponding signal to an acquisition unit.

In block 304, the acquisition unit measures the corresponding signal output by the signal generator to produce measurement data, compares the measurement data to standard data to produce an analysis result, and sends the analysis result to the control unit.

In block 306, the control unit sends the analysis result to a screen or a remote device to display.

In block 308, the electronic device determines faults of the different signals by individually comparing the measurement data of each signal to the standard data.

The electronic device 10 comprises the signal generator 108, the selecting unit 106, the acquisition unit 110, the storing unit 102, and the control unit 104. The control unit 104 outputs a control signal to the selecting unit 106. The selecting unit 106 receives the control signal, to select a corresponding input of the selecting unit 106 to connect to a corresponding output of the signal generator 108, to output a corresponding signal. The acquisition unit 110 measures the corresponding signal to produce measurement data, and compares the measurement data and a standard data to produce an analysis result, and send the analysis result to the control unit 104. The control unit 104 sends the analysis result to the screen 103 or the remote device 12 to display.

Many details are often found in the art such as the other features of a shielding plate. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a signal generator comprising a plurality of outputs to output a plurality of different signals;
a selecting unit comprising a plurality of inputs, an output, and a control port, wherein each of the plurality of inputs are electronically connected to each of the plurality of outputs of the signal generator respectively to receive the plurality of different signals outputted by the signal generator;
a storing unit storing a table which stores a relationship between the plurality of inputs of the selecting unit and the plurality of different signals;
a control unit electronically connected to the storing unit and the control port of the selecting unit, to read the table from the storing unit, to provide the plurality of different signals in the table of the storing unit to a user to select as a measurement target, and to output a control signal to the selecting unit according to the measurement target selected by the user and the relationship stored in the table, wherein the selecting unit selects a corresponding input of the selecting unit to electronically connect to a corresponding output of the signal generator according to the control signal, to control the signal generator to output a corresponding signal; and
an acquisition unit receiving the corresponding signal output by the signal generator, measuring the corresponding signal to produce measurement data, comparing the measurement data and a standard data to produce an analysis result, and sending the analysis result to the control unit, wherein the control unit further shows the analysis result.

2. The electronic device of claim 1, wherein the electronic device determines faults of the different signals by individually comparing the measurement data of each signal to the standard data.

3. The electronic device of claim 1, further comprising a screen, wherein the user select the target signal to measure via the screen, and the control unit controls the analysis result to display on the screen.

4. The electronic device of claim 1, wherein the control unit is connected to a remote device, the user select the target signal to measure via the remote device, and the control unit sends the analysis result to the remote device to display.

5. The electronic device of claim 1, wherein the different signals comprises a field programmable gate array/complex programmable logic device (FPGA/CPLD) signal, a power signal, and a bus signal.

6. The electronic device of claim 1, wherein the electronic device is a server, and the storing unit is a basic input output system (BIOS) of a baseboard in the server.

7. The electronic device of claim 6, wherein the control unit is a baseboard management controller (BMC) in the server.

8. The electronic device of claim 1, wherein the control signal is a level signal.

9. A fault analyzing method of an electronic device comprising:
providing a plurality of different signals in a table of a storing unit of the electronic device to a user to select as a measurement target, and outputting a control signal to a selecting unit of the electronic device according to the signal selected by the user and a relationship stored in the table, wherein the table stores a relationship between a plurality of outputs of the selecting unit and a plurality of different signals outputted by a signal generator of the electronic device;
selecting a corresponding input of the selecting unit to connect to a corresponding output of the signal generator according to the control signal, and the signal generator outputting a corresponding signal to an acquisition unit of the electronic device; and
measuring the corresponding signal to produce measurement data, comparing the measurement data and a standard data to produce an analysis result, and sending the analysis result to a control unit of the electronic device, wherein the control unit further shows the analysis result to the user.

10. The fault analyzing method of the electronic device of claim 9, further comprising:
determining faults of the different signals by individually comparing the measurement data of each signal to the standard data.

11. The fault analyzing method of the electronic device of claim 9, wherein the electronic device comprises a screen, the user select the target signal to measure via the screen, and the control unit controls the analysis result to display on the screen.

12. The fault analyzing method of the electronic device of claim 9, wherein the control unit is connected to a remote device, the user select the target signal to measure via the remote device, and the control unit sends the analysis result to the remote device to display.

13. The fault analyzing method of the electronic device of claim 9, wherein the different signals comprises a field programmable gate array/complex programmable logic device (FPGA/CPLD) signal, a power signal, and a bus signal.

14. The fault analyzing method of the electronic device of claim 9, wherein the electronic device is a server, and the storing unit is a basic input output system (BIOS) of a baseboard in the server.

15. The fault analyzing method of the electronic device of claim 14, wherein the control unit is a baseboard management controller (BMC) in the server.

16. The fault analyzing method of the electronic device of claim 9, wherein the control signal is a level signal.
